(19) United States
(12) Patent Application Publication
(10) Pub. No.: US 2017/0201475 A1
(43) Pub. Date: Jul. 13, 2017

(54) METHOD FOR DELIVERING CONTEXTUAL HEALTHCARE SERVICES AND ELECTRONIC DEVICE SUPPORTING THE SAME

(71) Applicant: Samsung Electronics Co., Ltd, Gyeonggi-do (KR)

(72) Inventors: Ankur Gupta, Meerut (IN); Ashoka Prem P, Kerala (IN); Pushpendra Prakash Sagar, Chandausi (IN); Saurabh Deb, Delhi (IN); Theophilus Thomas, Visakhapatnam (IN); Vishal Patwa, Noida (IN); Ankur Sardana, Haryana (IN); Avirup Basu, West Bengal (IN)

(21) Appl. No.: 15/390,440

(22) Filed: Dec. 23, 2016

(30) Foreign Application Priority Data
Jan. 7, 2016 (IN) 201611000631
Apr. 20, 2016 (KR) 10-2016-0048286

(51) Int. Cl. H04L 12/58; G06F 3/0488

(52) U.S. Cl. CPC H04L 51/04; H04L 51/12; H04L 51/24; G06F 3/04883

(57) ABSTRACT

The present disclosure relates to a method for delivering a contextual healthcare service and an electronic device supporting the same. The method for delivering a contextual healthcare service according to various embodiments of the present disclosure may include the operations of generating at least one contextual group including at least one message having an identical context in an ongoing chat and displaying the at least one contextual group in the ongoing chat. The method may further include performing an operation according to the at least one contextual group in response to a user gesture. The operation according to the at least one contextual group may include expanding or collapsing the at least one contextual group.

### CROSS-REFERENCE TO RELATED APPLICATION(S) AND CLAIM OF PRIORITY

The present application is related to and claims the priority under 35 U.S.C. §119(a) of an Indian Provisional patent application filed on Jan. 7, 2016 in the Indian Patent Office and assigned Serial Number 201611000631, of an Indian Patent Application filed on Apr. 7, 2016 in the Indian Patent Office and assigned Serial Number 201611000631, and of a Korean Patent Application filed on Apr. 20, 2016 in the Korean Patent Office and assigned Serial Number 10-2016-0048286 the entire disclosure of each of which is hereby incorporated by reference.

### TECHNICAL FIELD

The disclosure generally relates to the field of context awareness and, more particularly, to a method and an electronic device for context-aware chat management.

### BACKGROUND

At present, chat services have become very popular as they offer instantaneous transmission of chat messages from a sender to one or more receivers through a network, NFC (Near Field Communication), or the Internet, etc. A typical chat message may include a text, image, audio, video, location, contact, or the like. Chat services may involve direct communications between individuals, or may involve group communications, wherein communication occurs from one sender to many receivers.

In any chat service, a user has access to contact list that includes the names or identifications of other users with whom communication may be desired in the future. When users identified in the contacts list connect to the network, the user is notified with network connection of users identified in the contact list, so that an interactive chat session can begin. During the interactive chat session, the instant messages between users are contemporaneously routed to the users' electronic devices and can be displayed on a pop-up window or display area of a display screen. In this way, two or more users may converse with one another in a simulated real-time manner through messages. The unique features of instant messages (as opposed to email and forum posts, whether public or non-public) can provide users with the ability to engage in a near real-time conversation.

### SUMMARY

Conventional chat services may manage chat messages inefficiently in case that the number of chat messages in a chat session is great. Generally, the chat messages are sorted in an ascending order of time, for example, from past to present, and displayed from the top to the bottom of the chat session. The chat session must be continuously scrolled to see an old message which is not displayed on the current screen but undeleted, and thereby it may generate inconveniences of taking much time.

Various embodiments of the present disclosure provide a solution for improving the management of chat messages. Embodiments of the present disclosure can provide context-aware chat management basically. A long chat session may include short conversations and the short conversations may include artefacts for setting the context and supplementing the conversation. Accordingly, a chat session can be segmented into various contextual groups, which can be expanded or collapsed, for example, by zooming in or zooming out respectively, or a pinch open gesture or a pinch closed gesture respectively, clicking an expand button or a collapse button respectively. In various embodiments of the present disclosure, the context can be set automatically. Alternatively, the context can be changed manually by a user or a new context can be generated. If the context is set, at least one identical chat message and/or chat session can be displayed. In an embodiment, prepared chat objects can be sorted according to the set context so that a user can select one easily. The solutions provided by various embodiments of the present disclosure can be customized with a healthcare scenario for enabling an audio or video conference along with the context-aware chat management.

An electronic device according to various embodiments of the present disclosure may include a control unit configured to generate at least one contextual group including at least one message having an identical context in an ongoing chat, to display at least one context group in the ongoing chatting, and to control to execute an operation according to the at least one contextual group in response to a user gesture. The operation according to the at least one contextual group may include expanding and collapsing the at least one contextual group.

A method for delivering a contextual healthcare service according to various embodiments of the present disclosure may include the operations of: generating at least one contextual group including at least one message having an identical context in an ongoing chat; displaying the at least one contextual group in the ongoing chat; and performing an operation according to the at least one contextual group in response to a user gesture. The operation according to the at least one contextual group may include expanding or collapsing the at least one contextual group.

Various embodiments of the present disclosure can provide an effective management of chat messages, a new interaction to retrieve contextual groups in a chat session, and new functions.

In various embodiments of the present disclosure, a context can be divided into a plurality of contextual groups and most proper artefacts can be provided for supporting a conversation.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating an electronic device for context-aware chat management in a chat application according to various embodiments of the present disclosure;

FIG. 2 is a flowchart illustrating a method for managing a context-aware chat in a chat application according to various embodiments of the present disclosure;

FIGS. 3A to 3D illustrate a scenario for interacting a contextual healthcare chat according to various embodiments of the present disclosure;

FIGS. 4A and 4B illustrate a scenario for changing a context manually in a chat session according to various embodiments of the present disclosure;

FIGS. 5A to 5C illustrate a scenario for detecting a context generated by a user according to various embodiments of the present disclosure;

FIG. 6 illustrates a scenario for detecting a context automatically in a chat window according to various embodiments of the present disclosure;

FIGS. 7A and 7B illustrate a scenario for reflecting a chat context in a dashboard according to various embodiments of the present disclosure;

FIGS. 8A and 8B illustrate a scenario for determining the priority of emoticons on the basis of context according to various embodiments of the present disclosure;

FIGS. 8C to 8F are schematic drawings illustrating a scenario for detecting a location of pain and vitals according to various embodiments of the present disclosure; and

FIG. 9A to 9C are schematic drawing illustrating a healthcare scenario of utilizing context-aware chat management for an audio or video conference between multiple parties according to various embodiments of the present disclosure.

It may be noted that to the extent possible, like reference numerals have been used to represent like elements in the drawings. Further, those of ordinary skill in the art will appreciate that elements in the drawings are illustrated for simplicity and may not have been necessarily drawn to scale. For example, the dimensions of some of the elements in the drawings may be exaggerated relative to other elements to help to improve understanding of aspects of the disclosure. Furthermore, the one or more elements may have been represented in the drawings by conventional symbols, and the drawings may show only those specific details that are pertinent to understanding the embodiments of the disclosure so as not to obscure the drawings with details that will be readily apparent to those of ordinary skill in the art having the benefits of the description herein.

### DETAILED DESCRIPTION

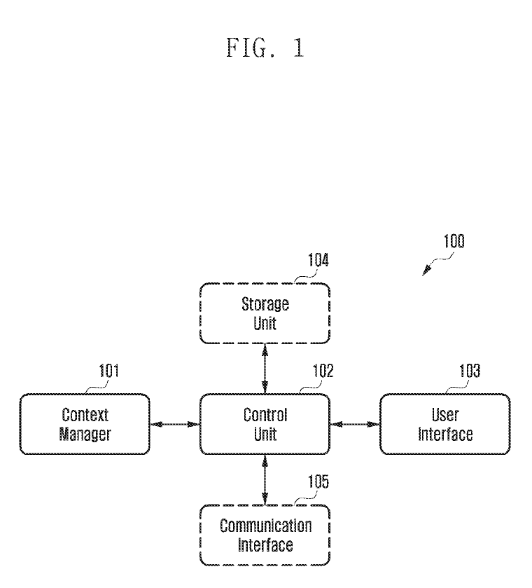

FIGS. 1 through 9C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are exemplary and explanatory of the disclosure and are not intended to be restrictive thereof. Throughout the patent specification, a convention employed is that in the appended drawings, like numerals denote like components.

Reference throughout this specification to “an embodiment”, “another embodiment” or similar language means that a particular feature, structure, or characteristic described in connection with the embodiment is included in at least one embodiment of the disclosure. Thus, the appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures proceeded by “comprises . . . a” does not, without more constraints, preclude the existence of other devices or other sub-systems.

Hereinafter, various embodiments of the disclosure will be described in detail with reference to the accompanying drawings.

FIG. 1 is a block diagram illustrating an electronic device 100 for context-aware chat management in a chat application according to various embodiments of the present disclosure

With reference to FIG. 1, the electronic device 100 may include a mobile phone, tablet computer, laptop computer, desktop computer, chat server, app server, and cloud computers, however the present is not limited to the above examples. The electronic device 100 may include at least one of a context manager, but are not limited to a mobile phone, a tablet computer, a laptop, a desktop computer, a chat server, an app server, and cloud computers.

The electronic device 100 may include at least one of a context manager 101, control unit 102, user interface 103, storage unit 104, communication interface 105, and other components (not shown).

The context manger 101 can manage a context and may be configured with a specific program (hardware or software) for controlling or executing processes in association with the control unit 102.

The control unit 102 may include one or more processors, microprocessors, microcontrollers, ACICs (Application Specific Integrated Circuits), FPGAs (Field Programmable Gate Arrays), or the like. The control unit 102 may control the operation of the electronic device 100 and its components integrally.

The user interface 103 may include a touch screen display for outputting or receiving information through the electronic device 100. The user interface 103 may include a speaker for receiving electrical signals and outputting audio signals; a camera lens for receiving image and/or video signals and outputting electrical signals; a microphone for receiving audio signals and outputting electrical signals; buttons (for example, control buttons and/or keys of a keypad) for inputting data and control commands through the computing device 100; one or more sensors for recognizing user gestures; a vibrator for vibrating the computing device 100; a display screen for outputting visual information; and LED (Light Emitting Diode).

The storage unit 104 may include a RAM (Random Access Memory), ROM (Read Only Memory), and/or other type of memories for storing data and instructions which can be used by the control unit 102. Further, the storage unit 104 may include routines, programs, objects, components, and data structures for performing specific tasks, functions, or abstract data.

The communication interface 105 may include a transceiver enabling communication between the electronic devices 100 and other devices and/or systems (for example, a server or a service provider). For example, the communication interface 105 may include a modem or an Ethernet interface for connecting to a LAN. Further, the communication interface 105 may include mechanisms for communicating through a network such as a wireless network. For example, the communication interface 105 may include a transmitter for converting baseband signals to RF (Radio Frequency) signals in the control unit 102 and/or a receiver for converting RF signals to baseband signals. Alternatively, the communication interface 105 may include a transceiver for performing functions both of the transmitter and the receiver. The communication interface 105 may connect to an optional antenna assembly (not shown) for transmitting and/or receiving the RF signals.

In various embodiments of the present disclosure, the communication interface 105 can establish a data connection with a chat server. Further, the communication interface 105 can establish a wireless or other type of connection with a partner service provider.

The electronic device 100 according to an embodiment of the present disclosure may include a context manager 101. The context manager 101 can generate at least one contextual group in an ongoing chat. The at least one contextual group may include one or more messages having an identical context.

In various embodiments of the present disclosure, the electronic device 100 may include a user interface 103. The user interface 103 may be configured to display the at least one contextual group in the ongoing chat and to perform an operation according to the at least one contextual group in response to a user gesture. In various embodiments of the present disclosure, the operation according to the at least one context group may include expanding or collapsing the at least one contextual group.

In another embodiment, the context manger 101 can automatically set a context for one or more messages in an ongoing chat.

In further another embodiment, the at least one contextual group can be automatically created in accordance with the automatically set context.

In further another embodiment, the user interface 103 can receive a user input for manually initiating or changing a context in the ongoing chat.

In further another embodiment, the at least one contextual group can be generated in accordance with the manually initiated or changed context.

In further another embodiment, the user interface 103 can display an icon corresponding to the context along with the one or more messages.

In further another embodiment, the context manager 101 can sort a plurality of objects inserted in the ongoing chat on the basis of the context. The user interface 103 can display the sorted objects in a chat application. According to the display of the sorted objects in the chat application, a user can select the sorted objects easily while chatting.

In further another embodiment, the user interface 103 can display an alert in the at least one contextual group if a new message is received in that contextual group.

In further another embodiment, the chat application is a healthcare chat application providing an easy exchange of EHR (Electronic Healthcare Records) and/or related information in real time between multiple parties.

In further another embodiment, the parties are a patient, a nurse, a doctor, and/or a specialist doctor, and the parties may be provided with different rights and functions as a user, an administrator, and a super user.

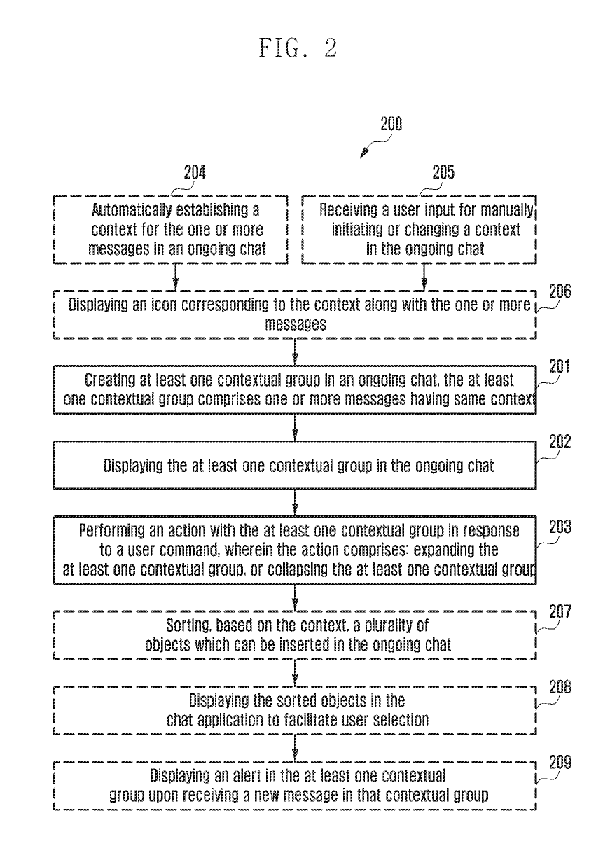

FIG. 2 is a flowchart illustrating a method 200 for managing a context-aware chat in a chat application according to various embodiments of the present disclosure.

In an embodiment of the present disclosure, the control unit 102 can generate at least one contextual group in an ongoing chat. The at least one contextual group may include one or more messages having an identical context in operation 201. The control unit 102 displays the at least one contextual group in the ongoing chat at operation 202. The control unit 102 performs an operation according to the at least one contextual group in response to a user gesture at operation 203. The operation according to the at least one contextual group may include expanding the at least one contextual group if the contextual group is collapsed, or collapsing the at least one contextual group if the contextual group is expanded.

In another embodiment, the control unit 102 sets a context for the one or more messages automatically in an ongoing chat at operation 204.

In further another embodiment, the at least one contextual group can be automatically generated in accordance with the automatically set context.

In further another embodiment, the control unit 102 receives a user input for initiating or changing a context manually in the ongoing chat at operation 205.

In further another embodiment, the at least one contextual group can be generated in accordance with the manually initiated or changed context.

In further another embodiment, the control unit 102 displays an icon corresponding to the context along with the one or more messages at operation 206.

In further another embodiment, the control unit sorts a plurality of objects inserted in the ongoing chat on the basis of the context at operation 207.

The control unit 102 displays the objects sorted according to the context in a chat application so that objects related to a conversation can be inserted in the ongoing chat at operation 208.

In further another embodiment, the control unit 102 displays an alert in at least one contextual group if a new message is received in the at least one contextual group at operation 209.

In further another embodiment, the chat application may be a healthcare chat application enabling an easy exchange of EHR (Electronic Healthcare Records) and/or related information in real time between multiple parties.

In further another embodiment, the parties may be a patient, a nurse, a doctor, and/or a specialist doctor, and the parties are provided with different rights and functions as a user, an administrator, and a super user.

Hereinafter, various embodiments of the present disclosure will be described with reference to a context chat in healthcare (for example, a chat between a doctor and a patient through a medical chat application). However the present disclosure is not limited to the above example and can be applied in the same manner to other chat applications, standalone chat program, or web-based chatting.

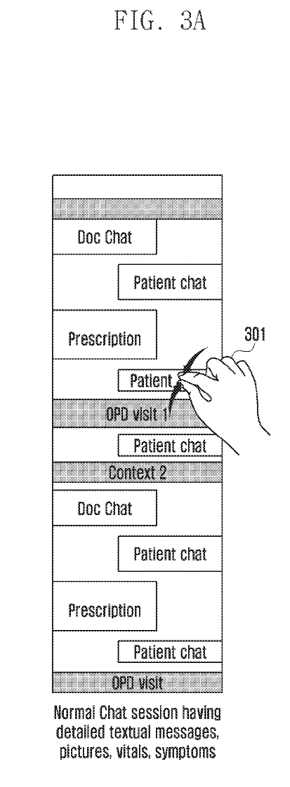

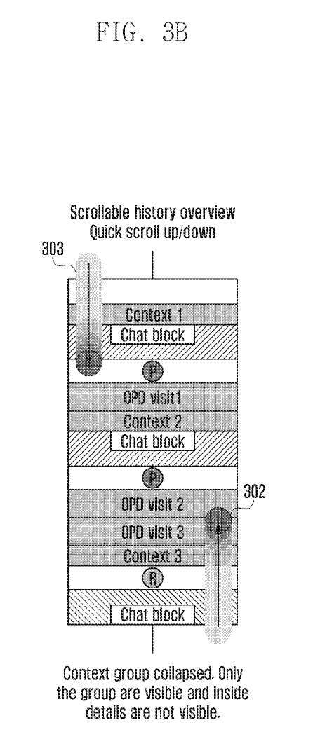

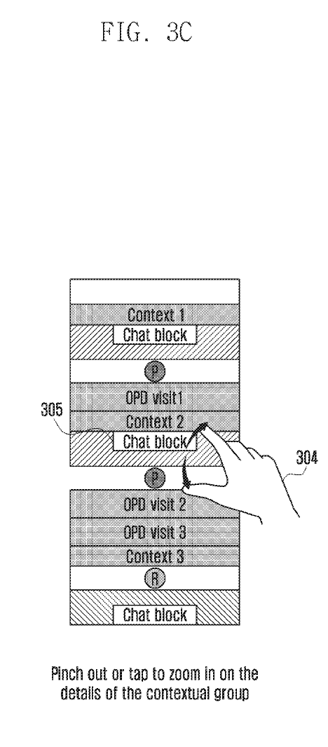

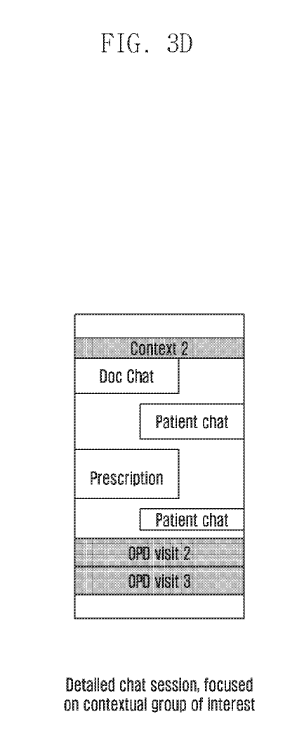

FIG. 3 is a schematic drawing illustrating a scenario for interacting a contextual healthcare chat which can be used to search contextual groups in a chat session according to various embodiments of the present disclosure,

With reference to FIG. 3, the control unit 102 can display general chat sessions including character messages, pictures, vitals, and symptoms. The control unit 102 can detect a user gesture 301 for sorting the messages on the basis of contexts (for example, OPD Visit 1 and prescription inquiry).

In various embodiments of the present disclosure, by expanding or collapsing messages continued through the user gesture 301 based on the context, a message search can be performed easily by using a scroll up 302 and/or a scroll down 303 as shown in FIG. 3B.

In various embodiments of the present disclosure, the control unit 102 can detect a user gesture (for example, pinch out 304 or tap to zoom in) in a specific contextual group (for example, chat block 305) of a context as shown in FIG. 3C.

In various embodiments of the present disclosure, if a user gesture (for example, pinch out 304 or tap to zoom in) is detected, the control unit 102 can display detailed items 306 of a specific contextual group 305 (for example, messages included in the specific contextual group 305) as shown in FIG. 3D. In various embodiments of the present disclosure, the control unit 102 can display the detailed items 306 of the specific contextual group 305 so that the detailed items 306 are focused on the specific contextual group 306.

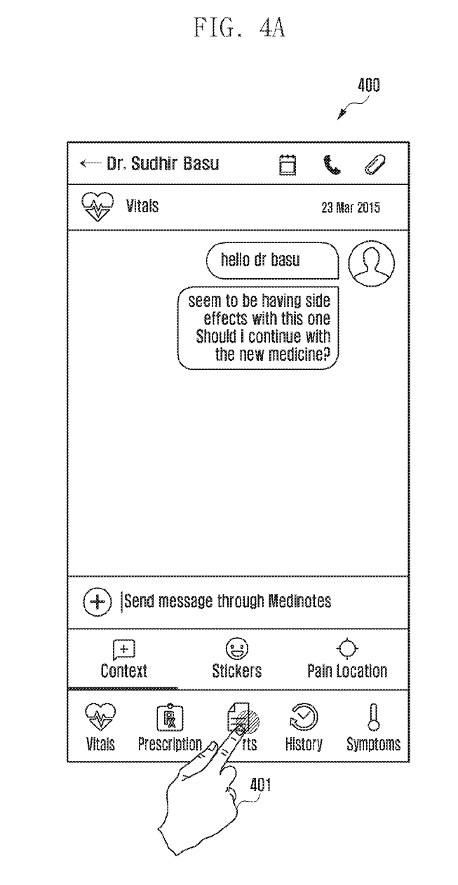

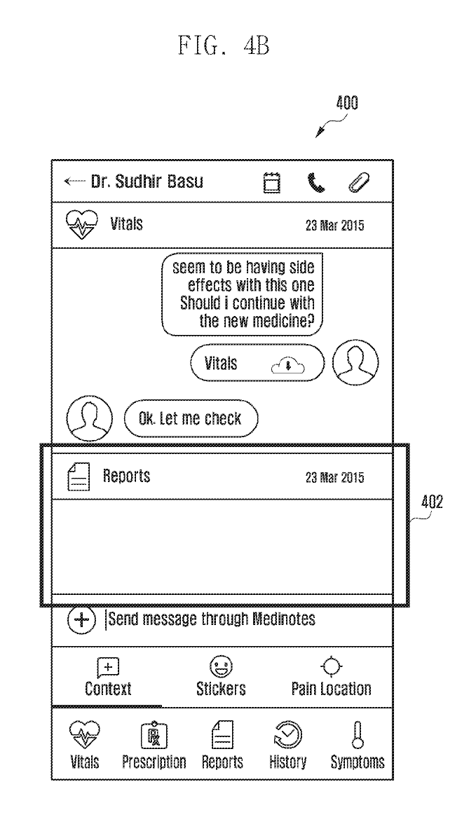

FIGS. 4A and 4B are a schematic drawings illustrating a scenario 400 for changing a context manually in a chat session according to various embodiments of the present disclosure.

FIG. 4A illustrates that a user input 401 can be provided for an artefact, so that a user can change a context manually or start a new context.

In various embodiments of the present disclosure, if the user input 401 is detected, the control unit 102 can change the context to a ‘Reports’ 402 as shown in FIG. 4B. The contextual group can be modified manually or generated on the basis of a newly started context.

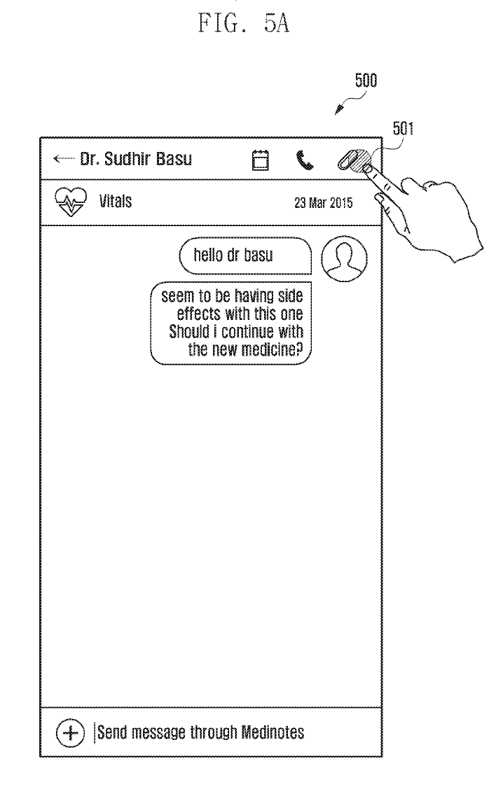

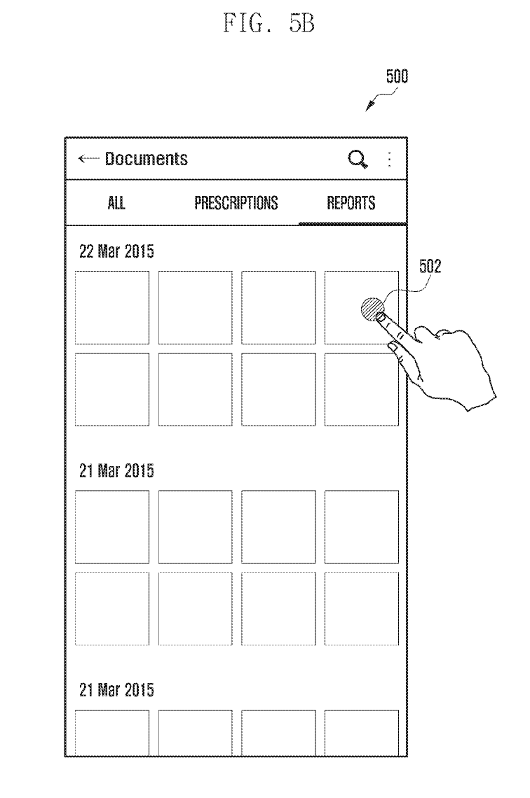

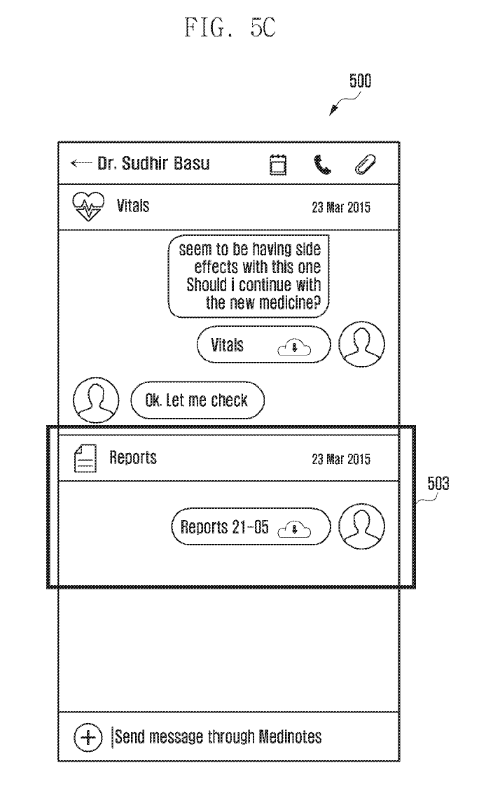

FIGS. 5A to 5C are a schematic drawings illustrating a scenario 500 for detecting a context generated by a user according to various embodiments of the present disclosure.

In various embodiments of the present disclosure, a context of a chat can be automatically changed by exchanging communication (for example, message). The control unit 102 can divide a continuous chat into various contextual groups according to the automatically changed context. For example, the control unit 102 can detect an input for selecting an attachment 501 to be transmitted in a chat session as shown in FIG. 5A. The attachment may include a report 502 as shown in FIG. 5B. If the report is transmitted as an attachment in a chat, the control unit 102 can change a context 503 reflected in a user interface as shown in FIG. 5C. The contextual group can be generated on the basis of changed context 503.

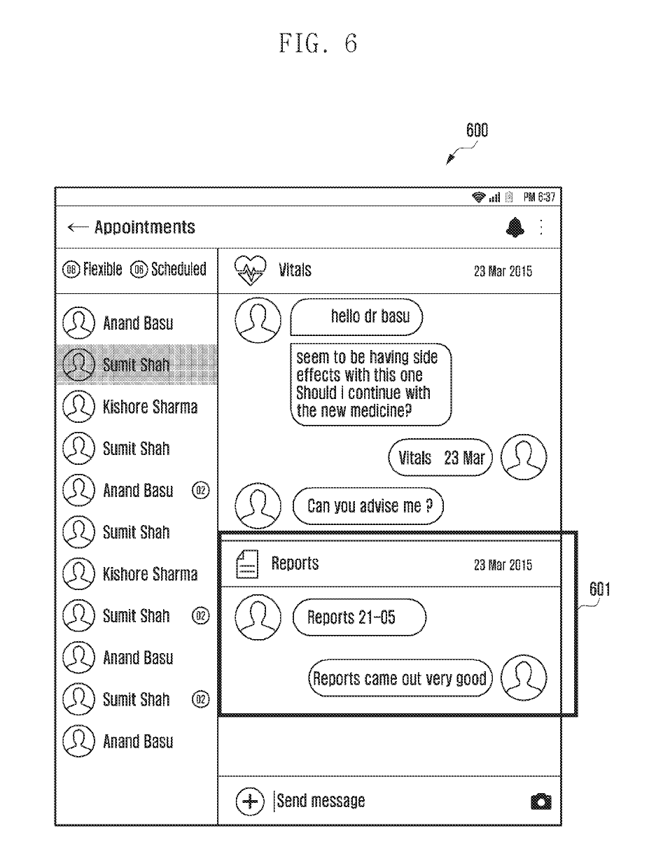

FIG. 6 is a schematic drawing illustrating a scenario 600 for detecting a context automatically in a chat window according to various embodiments of the present disclosure.

In various embodiments of the present disclosure, FIG. 6 illustrates that a doctor changed an automatically received context 601 if a patient transmits a report to the doctor. Accordingly, a contextual group can be generated by the doctor on the basis of the automatically set context 601.

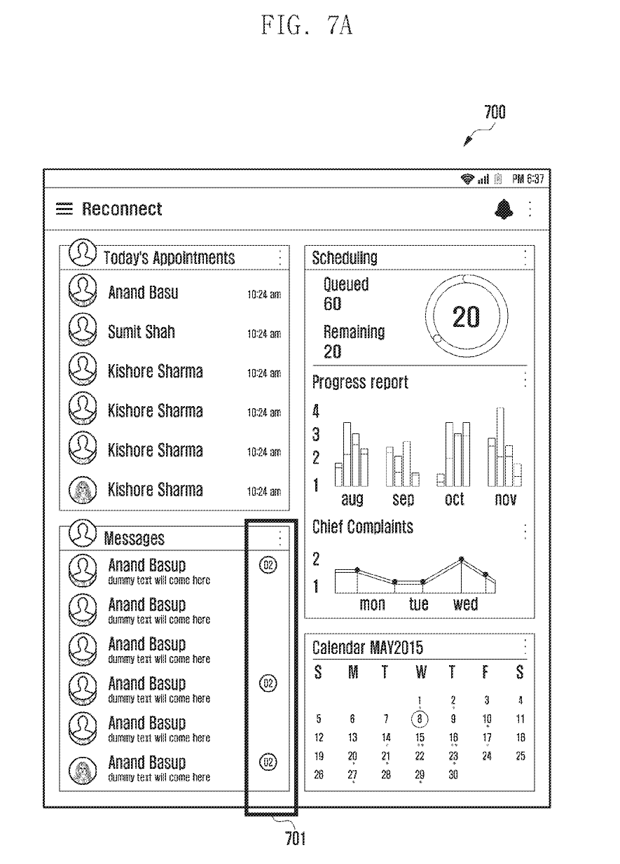

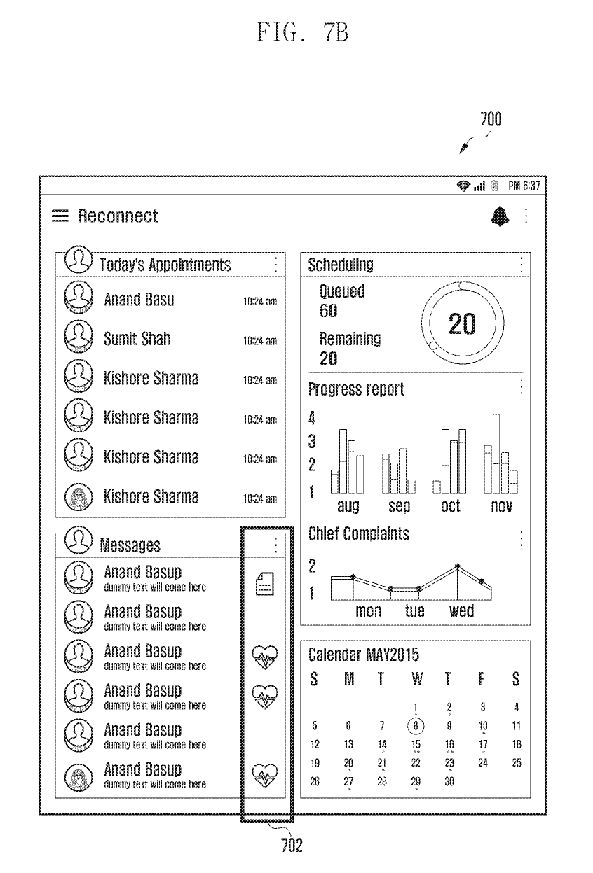

FIGS. 7A and 7B are schematic drawings illustrating a scenario 700 for reflecting a chat context in a dashboard according to various embodiments of the present disclosure.

In various embodiments of the present disclosure, the current chat context can be reflected in a doctor's dashboard. The control unit 102 can provide a flip animation effect to display general icons 701 and an appointment form for examination in a chat context 702 shown in FIG. 7B.

In an embodiment, if a new message is received in a contextual group, the control unit 102 can display an alert in the contextual group which received the new message.

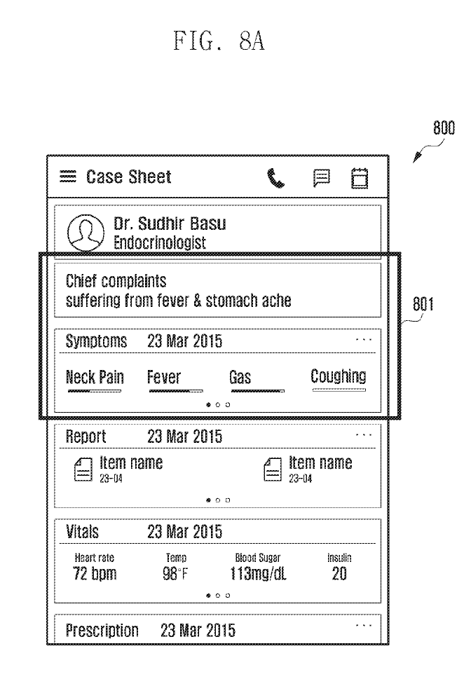

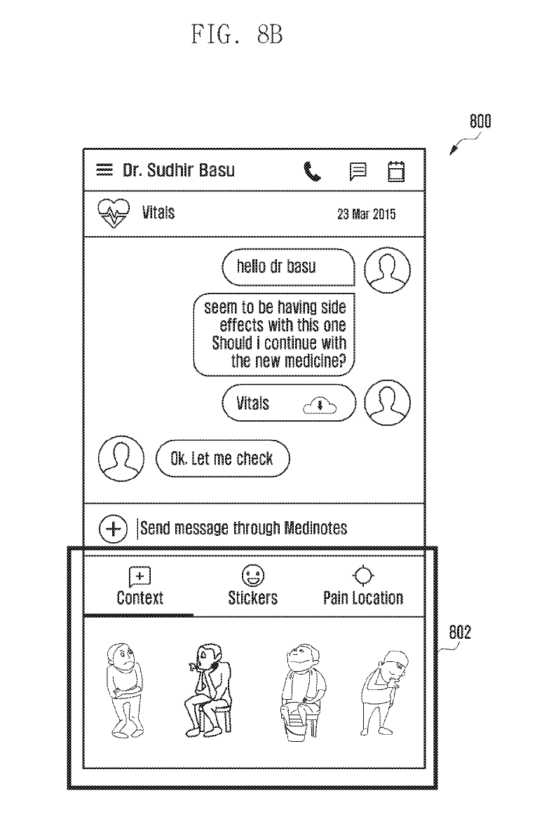

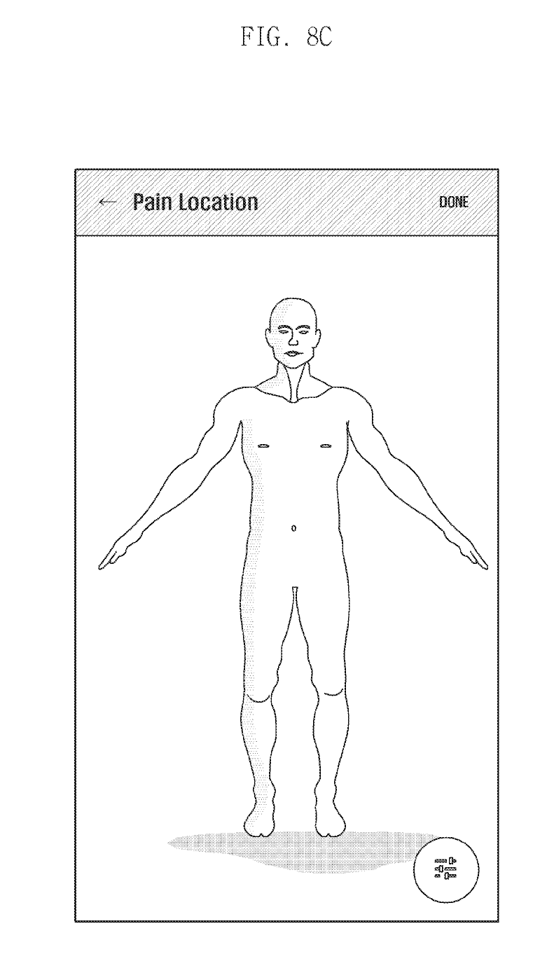

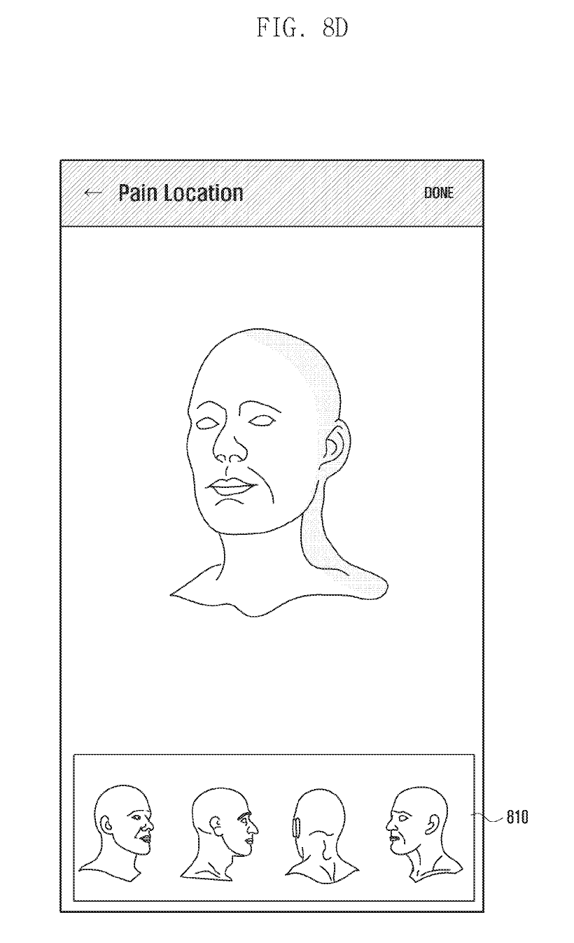

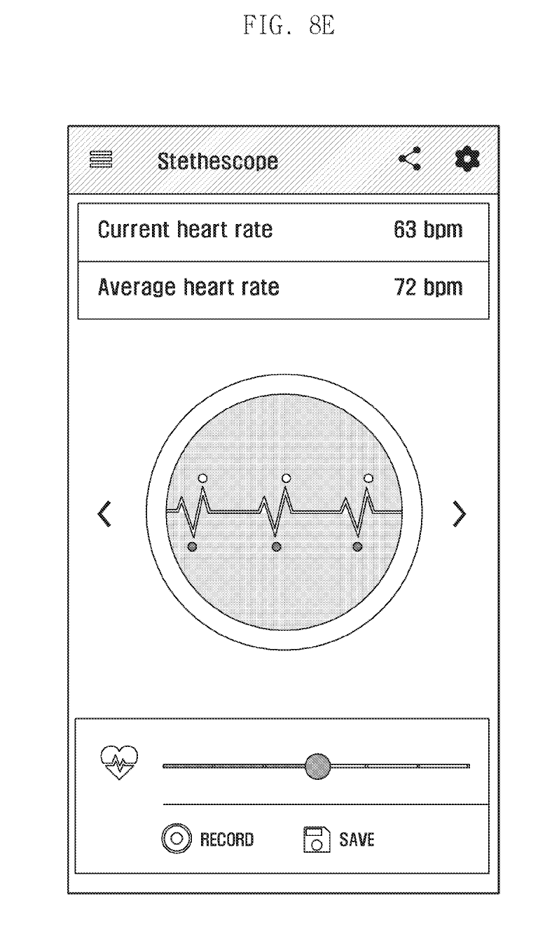

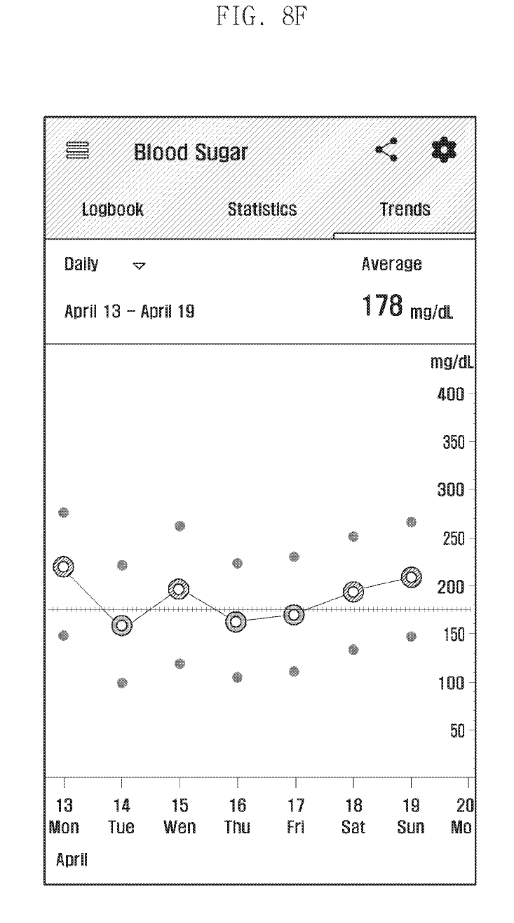

FIGS. 8A and 8B are schematic drawings illustrating a scenario 800 for determining the priority of emoticons on the basis of context according to various embodiments of the present disclosure.

As an embodiment, the control unit 102 can set the priority of emoticons/stickers on the basis of patient's major diseases and pains. As shown in FIGS. 8A and 8B, the control unit 102 can control to display emoticons/stickers related to the type of patient's major diseases/symptoms first. For example, the control unit 102 can display 802 by rearranging the emoticons/stickers related to the patient's major diseases/symptoms 801 according to the priority. In various embodiments of the present disclosure, the type of patient's diseases/symptoms can be input by the patient. This will be described in more detail with reference to FIGS. 8C to 8F.

In various embodiments of the present disclosure, it is assumed that emoticons/stickers related to patient's major diseases/symptoms are displayed by rearranging according to the priority. However, the present disclosure is not limited to this assumption and the control unit 102 can display artefacts such as images, videos, audios, contacts, and locations inserted in a chat session, or external objects by assorting according to a set context. Accordingly a user can select the sorted and displayed artefacts/external objects 802 quickly and easily. Namely, various embodiments of the present disclosure can provide abundant experience for a user.

For example, if two friends are chatting about a person having a name XYZ and one of the friends wants to transmit XYZ's contact details in the chat session, the contact list of XYZ can be automatically sorted on the basis of an identified context. Namely, all the contacts having the name XYZ can be displayed first in a sorted contact list. In this way, the time required for searching contact details from a contact book can be reduced.

FIGS. 8C to 8F are schematic drawings illustrating a scenario for detecting a location of pain and vitals according to various embodiments of the present disclosure.

In various embodiments of the present disclosure, as shown in FIG. 8C, a patient can precisely mark a pain location on a human body map which helps a doctor determine the pain location quickly to provide a diagnosis of the ailment. In various embodiments of the present disclosure, the pain location can be marked through a pin point. The user can receive an accurate diagnosis of the doctor for the disease by accurately marking the pain location through the pin point. In various embodiments of the present disclosure, the human body map can be displayed in a 3D depiction which is interactive and rotatable in the 3 axes. The control unit 102 can detect an input of marking a pain location in the human body map displayed in the 3D depiction. The control unit 102 can determine the position where the input is detected as a pain position and display the position on the human body map in a distinguishable manner. If a user gesture such as a pinch zoom or a long tap gesture is detected, the control unit 102 can display a portion of the body in detail by expanding the portion of the body. The control unit 102 can further detect an input for marking a pain location. The control unit 102 can display a plurality of pain locations in the human body map responding to the input for marking.

In various embodiments of the present disclosure, as shown in FIG. 8D, the control unit 102 can display a detailed view in a 2D depiction by zooming a portion of the body according to a layer structure. Various embodiments of the present disclosure can display body views and selected segments 810 in various angles/directions so that a user can mark a pain location. A plurality of pain locations can be displayed in one of the body views. If the pain location is marked in a chat or independently, the pain location can be automatically updated in a patient case sheet. In various embodiments of the present disclosure, the history of the pain location can be used by both of the doctor and the patient so that the pain location can be traced for a predetermined period. The pain location can be displayed as an executable chat object in a messenger.

As shown in FIG. 8E, the electronic device according to various embodiments of the present disclosure provides a vital measurement system so that a patient can measure vitals conveniently at home. The patient can measure the vitals necessary for diagnosis or supplementary information for a doctor by using a personal healthcare device. In various embodiments of the present disclosure, the personal healthcare devices can transfer the measured vitals to a mobile device or any other data collecting module.

In various embodiments of the present disclosure, device data can be accessed by a patient or a doctor in various methods such as a time interval. In various embodiments of the present disclosure, the electronic device can estimate average/medium readings, peak readings, and pattern for patient's vitals from the data. The personal healthcare device can measure patient's vitals through a device panel or remotely. A plurality of devices (for example, personal healthcare devices) can be synchronized with a mobile device and the data can be stored in a cloud server. However the present disclosure is not limited to this and readings of vitals can be input by a user directly in various embodiments of the present disclosure.

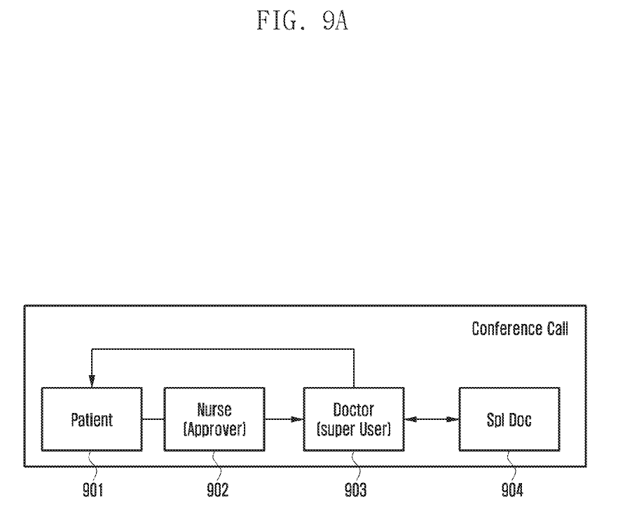

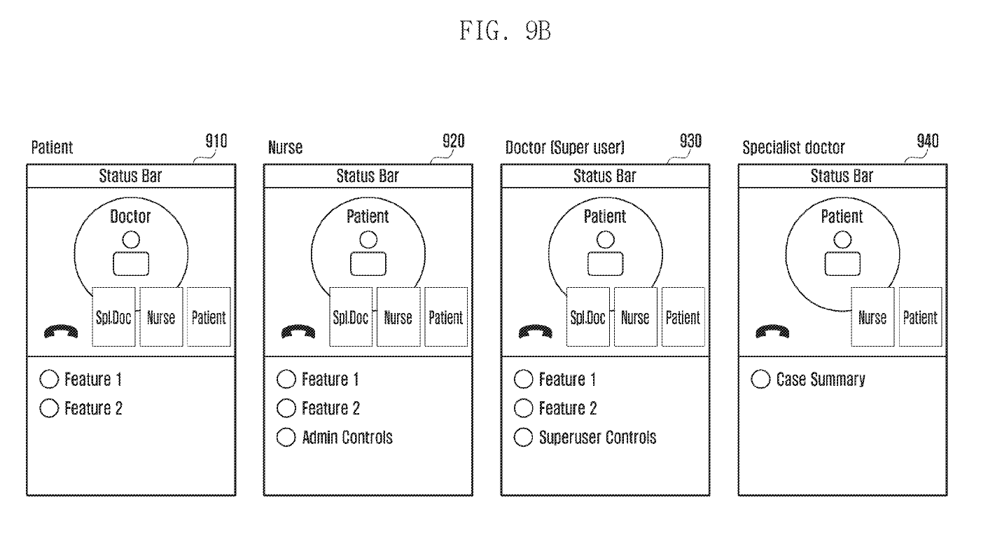

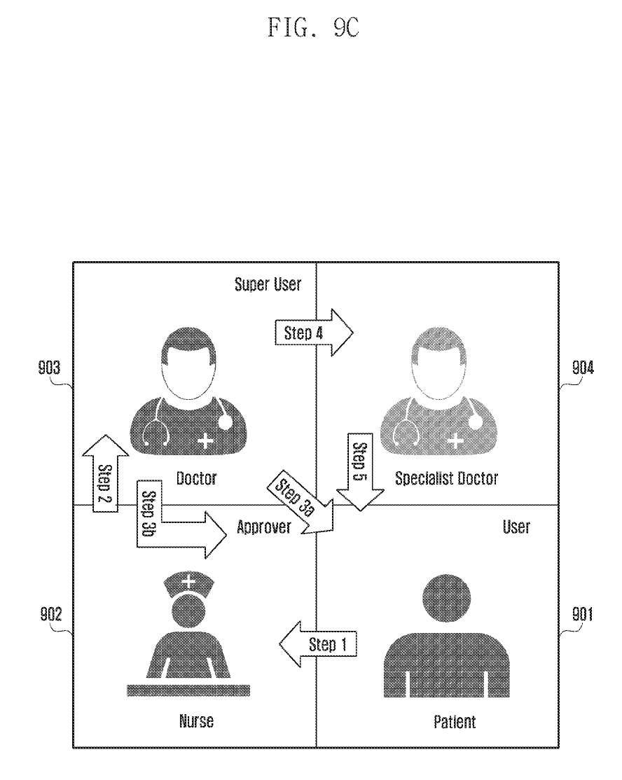

FIG. 9A to 9C are schematic drawing illustrating a healthcare scenario of utilizing context-aware chat management for an audio or video conference between multiple parties according to various embodiments of the present disclosure.

FIG. 9A illustrates a scenario for exchanging healthcare information in real time, such as an EHR (Electronic Health Records) in a multi-party conference between a patient 901 and a nurse 902 as well as a doctor 903. The multi-party conference can be started with a context-aware chat according to various embodiments of the present disclosure, and the parties can share information, documents, and multimedia content. Further, audio/video calls can also be made by one or more parties to other parties in the multi-party conference. If necessary, a specialist doctor 904 can join in the conference as a party. In a specific healthcare scenario, the doctor 903 in charge of the patient 901 may request a specialist doctor 904 for a professional opinion. In various embodiments of the present disclosure, the doctor 903 interacting with the patient 901 may arbitrate a conference as a ‘super user’ and have the right as a specialist doctor 904. Prior to this, the nurse 902 as an ‘approver’ may approve the conference requested by the patient 901 as a ‘user’.

FIG. 9B illustrates screens 910 to 940 provided respectively for a patient 901, nurse 902, and a specialist doctor 904. As shown in the drawing, the screen 910 provided for the patient 901 may include audio/video communication options with other parties of the conference by adding characteristics according to various embodiments of the present disclosure. The screen 920 provided for the nurse 902 may include characteristics according to various embodiments of the present disclosure audio/video communication options with other parties of the conference, and management level control. The screen 940 provided for the specialist doctor 904 may include a treatment summary (contextual group according to various embodiments of the present disclosure) and audio/video communication options with the doctor 903. In the meantime, the screen 930 provided for the doctor 903 may include characteristics according to various embodiments of the present disclosure, audio/video communication options with other parties of the conference, and super user level control.

FIG. 9C illustrates steps related to connections of all the parties to the conference. The patient 901 can connect to the nurse 902 through the conference to get an opinion on his/her disease at Step 1. If the nurse 902 cannot response to the patient's inquiry or the patient is in a serious/critical situation, the nurse may receive the right from the conference so that the consulting doctor 903 can connect to a loop for processing the patient's inquiry at Step 2. The patient 901 may not have the right to contact the doctor 903 directly in order not to disturb the doctor in a busy schedule. If necessary, the nurse 902 can take a role of intermediary gate keeper to evaluate an inquiry to the doctor 903 and importance of participating in the conference. The doctor 903 may have the right to refuse an inquiry of loop participation from the nurse 902, and can contact the patient directly at Step 3a or along with the nurse in the loop at Step 3b.

In the process of consulting, if the doctor 903 needs an opinion/feedback from the specialist doctor 904 in the same or different hospital, the doctor 903 can let the specialist doctor 904 to participate in the loop at Step 4 in order to obtain a professional feedback at Step 5. In various embodiments of the present disclosure, only the consulting doctor 903 can let the specialist doctor to participate in the loop and all the communication between the doctor 903 and the specialist doctor may be designed to be integrated. In various embodiments of the present disclosure, only the consulting doctor 903 can share EHR (Electronic Health Records) of a patient and patient treatment records prepared by the doctor 903 and the nurse 902 in real time with the specialist doctor 904.

The consulting doctor 903 is the major party of the conference and can secure a specific action plan for the patient's welfare by monitoring patient's 901 difficulties properly and transferring them to the specialist doctor 904. The communication between the specialist doctor 904 and the patient 901 is controlled by the consulting doctor 903 as a super user at Step 5, and the patient 901 and the specialist doctor cannot contact directly. Only the consulting doctor 903 has the rights to share patient information with the specialist doctor 904 and can modify the patient information.

Embodiments of the disclosure have been described in detail for purposes of clarity and understanding. However, it will be appreciated that certain changes and modifications may be practiced within the scope of the appended claims. Thus, although the disclosure is described with reference to specific embodiments and figures thereof, the embodiments and figures are merely illustrative, and not limiting of the disclosure. Rather, the scope of the disclosure is to be determined solely by the appended claims.

What is claimed is:

1. An electronic device comprising:
a control unit configured to:
generate at least one contextual group including at least one message having an identical context in an ongoing chat,
display at least one context group in the ongoing chat, and
in response to a user gesture, control to execute an operation according to the generated at least one contextual group,
wherein the operation according to the generated at least one contextual group comprises expanding or collapsing the displayed at least one contextual group.

2. The electronic device of claim 1, wherein the control unit is configured to automatically set a context for the displayed at least one message.

3. The electronic device of claim 2, wherein the control unit is configured to generate the at least one contextual group automatically, based on the automatically set context.

4. The electronic device of claim 1, wherein the control unit is configured to receive a user input for manually initiating or changing a context in the ongoing chat.

5. The electronic device of claim 4, wherein the control unit is configured to generate the at least one contextual group based on the manually initiated or changed context.

6. The electronic device of claim 1, wherein the control unit is configured to display an icon corresponding to the context along with the at least one message.

7. The electronic device of claim 1, wherein the control unit is configured to:
sort a plurality of objects inserted in the ongoing chat based on the context, and
display the plurality of sorted objects based on the context in a chat application.

8. The electronic device of claim 1, wherein, the control unit is configured to display an alert in at least one contextual group if a new message is received in the at least one contextual group.

9. The electronic device of in claim 1, wherein the control unit is configured to exchange at least one of electronic healthcare records (EHR) or related information in real time between multiple parties by providing or continuing the chat using a healthcare chat application.

10. The electronic device of claim 9, wherein the multiple parties comprise at least two of a patient, a nurse, a doctor, or a specialist; and
wherein the control unit is configured to provide the multiple parties with different rights and functions based on classifications including a user, an administrator, and a super user.

11. A method for delivering a contextual healthcare service, the method comprising:
generating at least one contextual group including at least one message having an identical context in an ongoing chat;
displaying the at least one contextual group in the ongoing chat; and
in response to a user gesture, executing an operation according to the generated at least one contextual group,
wherein the operation according to the generated at least one contextual group comprises expanding or collapsing the displayed at least one contextual group.

12. The method of claim 11 further comprising:
automatically setting a context for the displayed at least one message.

13. The method of claim 12, wherein generating the at least one contextual group automatically is based on the automatically set context.

14. The method of claim 11 further comprising:
receiving a user input for manually initiating or changing a context in the ongoing chat.

15. The method of claim 14, wherein generating the at least one contextual group is based on the manually initiated or changed context.

16. The method of claim 11, further comprising:
displaying an icon corresponding to the context along with the at least one message.

17. The method of claim 11, further comprising:
sorting a plurality of objects inserted in the ongoing chat based on the context; and
displaying the plurality of sorted objects based on the context in a chat application.

18. The method of claim 11, further comprising:
displaying an alert in at least one contextual group if a new message is received in the at least one contextual group.

19. The method of claim 11, further comprising exchanging at least one of electronic healthcare records (EHR) or related information in real time between multiple parties by providing or continuing the chat using a healthcare chat application.

20. The method of claim 19, wherein the multiple parties comprise at least two of a patient, a nurse, a doctor, or a specialist; and
wherein the multiple parties are provided with different rights and functions based on classifications including a user, an administrator, and a super user.
